(19) United States
(12) Patent Application Publication
(10) Pub. No.: US 2008/0000175 A1
(43) Pub. Date: Jan. 3, 2008

(54) FENCE AND SHUTTER SYSTEM

(76) Inventor: Ted Spoltore, Royal Palm Beach, FL (US)

Correspondence Address: MCHALE & SLAVIN, P.A., 2855 PGA BLVD, PALM BEACH GARDENS, FL, 33410, US

(21) Appl. No.: 11/427,554

(22) Filed: Jun. 29, 2006

(51) Int. Cl. E06B 3/26

(52) U.S. Cl. 52/202

(57) ABSTRACT

The present invention provides a fence and shutter system for homes, buildings and the like. The fence and shutter system according to the instant invention includes a panel constructed and arranged to be utilized as a section of fence when connected to permanently mounted posts, or as a storm shutter when secured across an aperture of a building. The panels include a plurality of strikers or catches, mounted on the end portions thereof, that are arranged to cooperate with a plurality of releasable receivers or similar hardware mounted to the posts or the surface of a building structure. This construction permits the panels to be secured to the posts for constructing a fence or to the surface of a building for protecting the aperture from high winds and/or windborne debris.

### FIELD OF THE INVENTION

This invention relates generally to storm shutters for protecting homes, buildings and other structures from wind and storm related damage; and more particularly to a fencing system that allows the fence panels to be utilized for storm shutters that provide resistance to hurricane force winds and impact from windborne debris.

### PRIOR ART BACKGROUND

The United States has experienced over 60 weather-related disasters in the past 25 years, each of which has caused in excess of $1 billion in damages. Together, these disasters have caused in excess of $350 billion in damage.

Population growth along the coastline of the United States has resulted in an increased risk to life and property from hurricane related damage. There are approximately 153 million residents that live in coastal counties of the United States, with areas such as Texas, Florida, and the Carolinas, where hurricanes frequently strike, experiencing rapid population growth. In addition, many coastal areas experience substantial but temporary population increases from holiday, weekend, and vacation visitors during hurricane season.

Homes, buildings, and other structures suffer substantial damage when storm generated winds, and particularly windborne debris, penetrate the structures through window and door openings. Hurricane shutters have long been used as barriers to protect window and door openings from the effects of storm generated winds. Equipping homes and other buildings with hurricane protection in the form of storm shutters is one of the most prudent actions one can take to protect life and property.

Accordingly, the background art reveals a number of storm shutters designed for removable installation on homes and buildings. Conventional storm shutters typically consist of corrugated metal panels affixed to the outside of a given structure. For example, U.S. Pat. No. 2,878,536, issued to Becker, discloses a shutter structure having overlapping corrugated panels. U.S. Pat. No. 4,333,271, issued to DePaolo et al., discloses a hurricane panel system for covering windows and doors. The '271 patent discloses a plurality of corrugated metal panels arranged in overlapping relationship to provide a protective structure. U.S. Pat. No. 5,345,716, issued to Caplan, discloses a storm shutter system comprising a combination of individual, interlocking modular elements. U.S. Pat. No. 5,852,903, issued to Astrizky, discloses a hurricane shutter comprising a pair of normally open doors that are swingable to a closed position. U.S. Pat. No. 5,911,660, issued to Watson, discloses a storm panel comprising a plurality of interlocking tiles interlocked together by a plurality of dovetail joints. U.S. Pat. No. 5,918,430, issued to Rowland, discloses a removable storm shield comprising convex panels. U.S. Pat. No. 5,996,292, issued to Hill et al., discloses a perforated shutter system wherein at least one panel is formed of corrugations. U.S. Pat. No. 3,358,408, issued to Cooper et al., discloses an insulated light transmitting panel construction having corrugations in the side edges thereof. U.S. Pat. No. 4,685,261, issued to Seaquist, discloses a removable translucent storm shutter consisting of a ½″ thick polycarbonate sheet in an aluminum channel frame. U.S. Pat. No. 5,457,921, issued to Kostrzecha, discloses a storm shutter in the form of a “kit”. The kit includes a plurality of corrugated shatter-resistant and transparent plastic sheets fastened to the structure using a mounting mechanism and fasteners inserted through key-way slots. U.S. Pat. No. 4,384,436, issued to Green describes a combination hurricane shutter and security grill. The grill is mounted on the exterior of a window and includes variously shaped metallic bars to create an ornamental effect. L-shaped brackets are fastened to top and bottom latitudinal bars of the grill and provide channels to facilitate insertion of a shutter board which encloses the grill and associated window. The shutter board is fastened to the brackets with metallic wood screws to provide protection against severe weather conditions.

A significant disadvantage associated with shutters is that they require storage. Shutters are typically stored within the garage of the home consuming a significant portion of the available storage space. In addition, the inherent weight of the shutter panels requires a support structure to prevent the shutters from tipping or falling while stored. Still yet, due to the congested population of coastal areas, many families live in condominiums or apartments. Most of these dwellings do not have a garage or other space dedicated to shutter storage.

Fencing is another problem in coastal areas. Fences are often erected in congested areas to provide privacy and safety to the homeowner. In fact, many coastal areas have laws requiring fences to be built around swimming pools or yards that contain swimming pools to reduce pool related accidents. These fences are often constructed of wood, plastic, aluminum, steel or other structural material at great expense to the homeowner. The fences generally include a plurality of vertically oriented posts anchored within the ground and fence panels permanently affixed to and extending between the vertical posts. Due to the permanent and structural nature of fences, they are often damaged or destroyed by the strong winds generated in coastal storms.

For example, Itri et al., U.S. Pat. No. 4,465,262, discloses a portable expandable barrier which comprises a pair of fences slideably interconnected and releasably held in a desired orientation by locking means such as lock set cylinders. Nicholls, U.S. Pat. No. 5,364,076, discloses a fence structure including a barrier and elongated fence posts. The fence posts include T-shaped slots in which end portions of the fence sections are received prior to final assembly of the posts. In general these fences are constructed as permanent structures. Thus, removal of the panels to minimize storm related damage to the fence would require complete disassembly of the fence structure.

Therefore, what is needed in the art is a fence and shutter system that allows the fence panels to be utilized for fencing as well as window and/or door coverings during a storm. The system should provide a modular design that allows the panels to be removed from their attachment to the fence posts for securement over various apertures in the building structure. The panels should be constructed for easy installation and detachment for use as shutters or fence without the need for special tools or apparatus.

### SUMMARY OF THE PRESENT INVENTION

The present invention provides a fence and shutter system for homes, buildings and the like. The fence and shutter system according to the instant invention includes a panel constructed and arranged to be utilized as a section of fence when connected to permanently mounted posts, or as a storm shutter when secured across an aperture of a building. The panels include a plurality of strikers or catches, mounted on the end portions thereof, that are arranged to cooperate with a plurality of releasable receivers or similar hardware mounted to the posts or the surface of a building structure. This construction permits the panels to be secured to the posts for constructing a fence or to the surface of a building for protecting the aperture from high winds and/or windborne debris. This construction eliminates the need to store storm shutters between storms by allowing the panels to be used as fencing. Because the panels are substantially imperforate they provide privacy when used as fencing and security from wind-borne debris when used as aperture coverings. In addition, this construction substantially reduces or eliminates damage caused to fences by storm related high winds.

Therefore, it is an objective of this invention to provide a combination fence and storm shutter system.

It is another objective of the instant invention to provide a fence and storm shutter system capable of providing privacy as well as protecting building openings from windborne debris.

It is a further objective of the instant invention to provide a fence system which reduces or eliminates damage thereto caused from high winds.

It is yet another objective of the instant invention to provide a fence having removable panels constructed and arranged to be utilized as building aperture covers.

It is still yet another objective of the instant invention to provide a combination fence and shutter system wherein the fence panels are constructed and arranged for removal and replacement without further disassembly of fence components.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

While the novel features of the invention are set forth with particularity in the appended claims, the invention, both as to organization and content, will be better understood and appreciated from the following detailed description, taken in conjunction with the drawings, in which:

FIG. 1 is a perspective view, illustrating one embodiment of the instant invention wherein the panels are in cooperation with fence posts;

FIG. 2 is a perspective view illustrating a latch mechanism which may be utilized for the instant invention;

FIG. 3 is a perspective view illustrating a lockable latch mechanism which may be utilized for the instant invention to provide additional security;

FIG. 4 is a plan view illustrating the fence panel of FIG. 1 in cooperation with building structure for covering a window aperture;

FIG. 5 is a plan view illustrating a plurality of fence panels in cooperation with building structure for covering a large building aperture.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

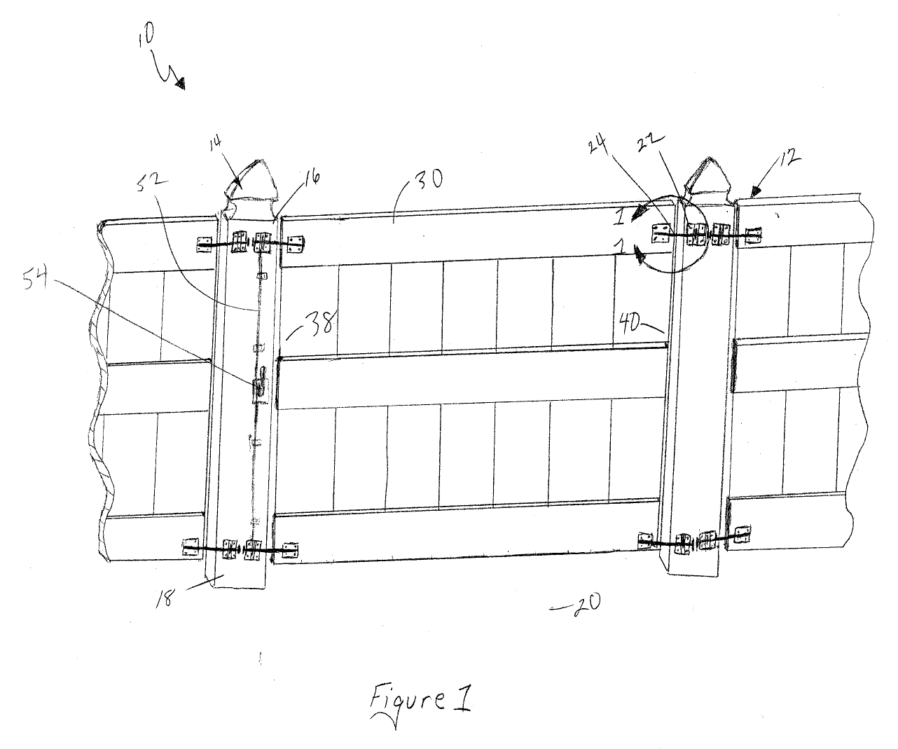

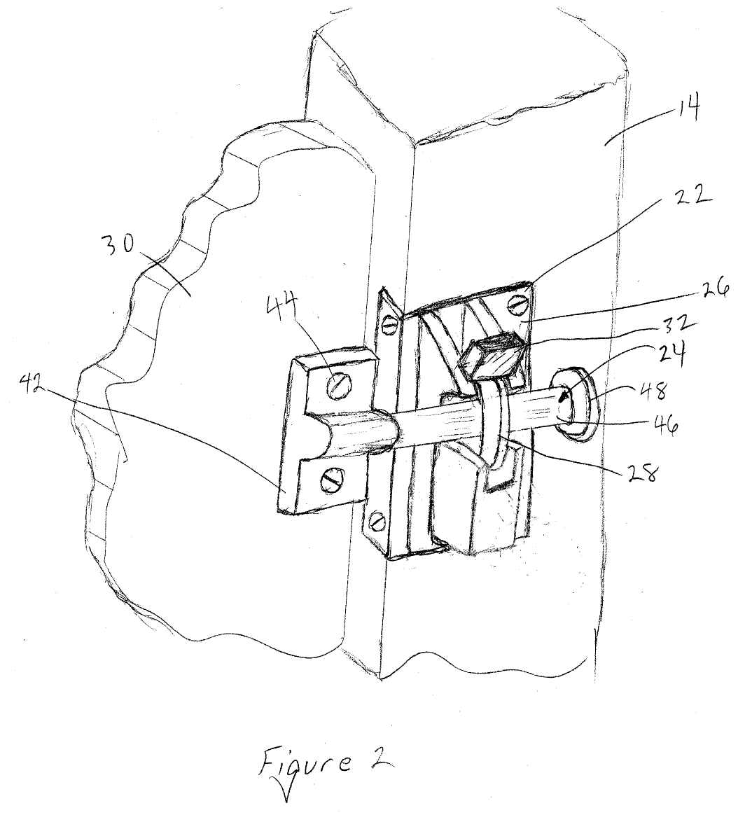

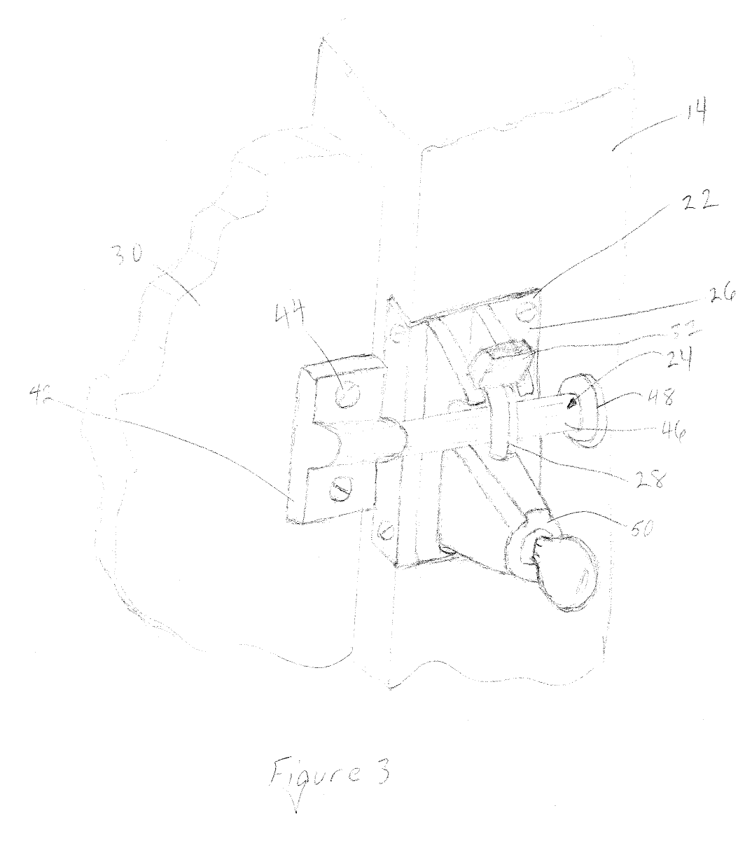

Referring to the Figures, a fence and storm shutter system 10 is illustrated. The fence and shutter system includes a panel constructed and arranged to be utilized as a section of fence when connected to permanently mounted posts or as a storm shutter when secured across an aperture of a building. FIG. 1 illustrates a preferred embodiment of the fence 12. The fence includes at least two spaced apart substantially vertical posts 14. The posts having an upper portion 16 and a lower portion 18, the lower portion constructed and arranged to be secured to a ground surface 20. The lower portion of the posts may be secured to the ground surface by any method well known in the art which may include, but should not be limited to, burying a portion of the post, setting a portion of the post in concrete, using fasteners or brackets to secure the post to a hard surface, weldment or any suitable combination thereof. Secured to both the upper and lower portions of the post are first latch portions illustrated herein as receivers 22 (FIGS. 2-3) generally constructed and arranged to cooperate with strikers 24 for selected retention of the panel member 30. The receivers may be secured to the posts by any suitable means well known in the art, which may include but should not be limited to, fasteners, adhesive, weldment, cast in place or any suitable combination thereof. The receiver includes a frame 26, and a latch bar 28. The latch bar is moveable between a latched position for retaining the striker member 24 and an unlatched position for releasing the striker member. The latch bar may include a lever 32 secured thereto for movement by hand. Alternatively, the latch bar may be operated by a cable 52 from a remote location. This configuration also permits multiple cables and latch bars to be operated from a single remote location as illustrated in FIG. 1. The cables may be manipulated by a hand-lever 54, knob or other suitable device. It should also be noted that other types of latch mechanisms, typically utilized for gates, doors and the like, that are suitable for securing a panel to posts or the side of a structure may be utilized without departing from the scope of the invention.

The panel 30 is generally imperforate in nature and includes a first end 38 and a second end 40, each end including second latch portions illustrated herein as at least two strikers 24 secured thereto. The strikers may be secured to the posts by any suitable means well known in the art, which may include but should not be limited to, fasteners, adhesive, weldment, cast in place or any suitable combination thereof. The strikers are generally constructed and arranged to cooperate with receivers 22 in an interlocking manner to secure the panel in a desired location with respect to fence posts or building apertures. The strikers of the preferred embodiment include a base portion having a plurality of apertures 44 therethrough for fasteners. The striker pin 46 extends outwardly from the base, terminating in an enlarged portion 48. In operation, the panels are secured to either the posts 14 or a structure 34 by aligning the strikers with the receivers, and pressing the assembly together. In the preferred embodiment, the strikers displace the latch bar in a direction substantially perpendicular to the plane of the panel. Once the striker is seated within the receiver the latch bar closes into place to secure the panel. To further secure the panel in place the receiver may include a lock mechanism 50 (FIG. 3). The lock mechanism is moveable between a locked position and an unlocked position, wherein the locked position prevents movement of the latch bar, and the unlocked position permits movement of the latch bar. The lock mechanism also provides security to the structure in the event the homeowner must evacuate for a storm by preventing the panels from being easily removed from the structure.

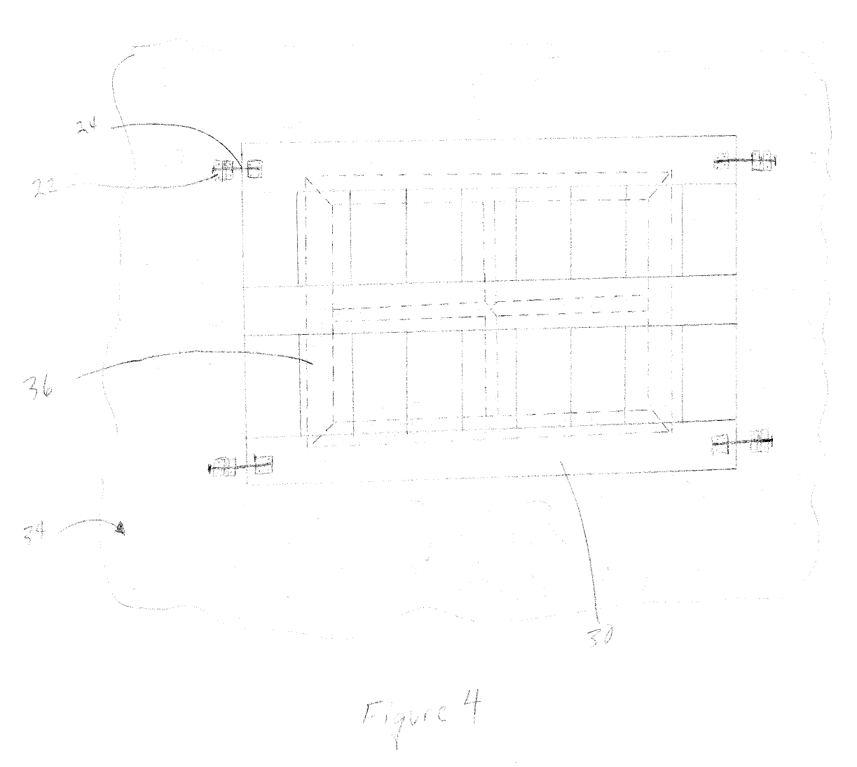

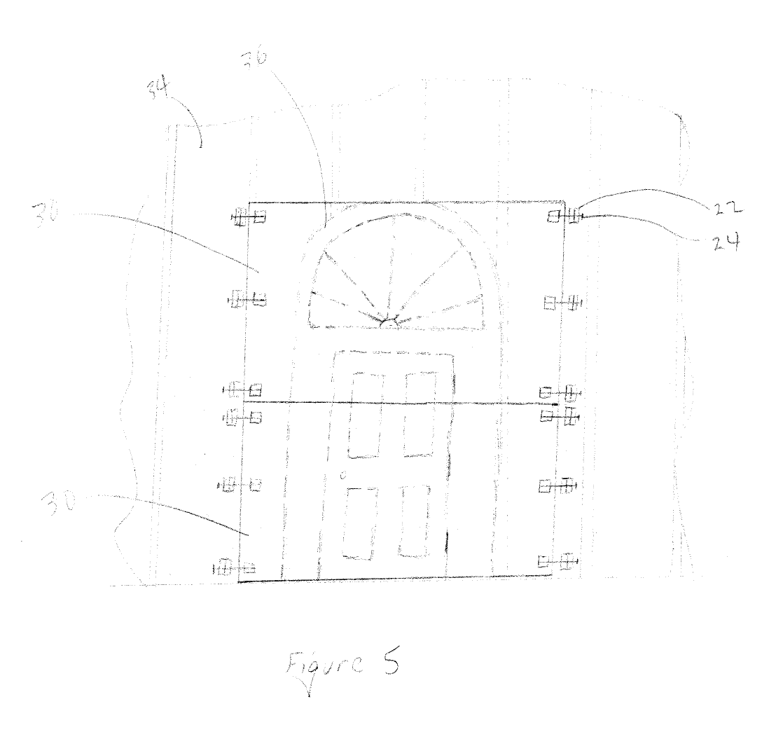

Referring to FIG. 4, a portion of a building structure 34 having an aperture in the form of a window 36 is illustrated. The structure is shown with a panel 30 secured over the window. The panel is generally sized to completely cover the aperture. Alternatively, as shown in FIG. 5, a plurality of panels in an abutted arrangement may be utilized to cover large apertures without departing from the scope of the invention. In either case, receivers 22 are utilized to secure the panel(s) in place. In a preferred embodiment at least one receiver, and more preferably two or more receivers, are used to secure each panel in place. The receivers are generally equally spaced around the aperture and secured to the outer surface of the building surface using suitable fasteners, adhesives or combinations thereof well known in the art. In this manner, the panels 30 may be secured between at least two posts in a substantially horizontal arrangement for assembling a fence. Alternatively, the panel(s) may be secured across a building aperture for protecting said aperture from high winds and flying debris.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fence and storm shutter system comprising:
a fence having at least two spaced apart substantially vertical posts, said posts having an upper portion and a lower portion, said lower portion constructed and arranged to be secured to a ground surface;
a plurality of first latch portions, said first latch portions constructed and arranged for attachment to a surface, wherein at least one of said first latch portions is secured to said upper portion and said lower portion of each said post, wherein at least two of said first latch portions are secured to opposite sides of a building aperture;
a panel having a first end and a second end each including at least two second latch portions secured thereto, wherein said second latch portions are constructed and arranged to cooperate with said first latch portions in an interlocking manner to secure said panel in a desired location;
whereby said panel may be secured between said at least two posts in a substantially horizontal arrangement for assembling a fence, and whereby said panel may be secured across said building aperture for protecting said aperture from high winds and flying debris.

2. The fence and storm shutter system of claim 1 wherein said panel is substantially imperforate.

3. The fence and shutter system of claim 1 wherein said first latch portion is a receiver and wherein said second latch portion is a striker, whereby said receiver is constructed and arranged to cooperate with said striker for selected retention and release thereof.

4. The fence and storm shutter system of claim 3 wherein said receiver includes a frame, and a latch bar portion, wherein said latch bar portion is moveable between a latched position for retaining said striker member and an unlatched position for releasing said striker member.

5. The fence and storm shutter system of claim 4 wherein said latch bar portion is displaced in a direction substantially perpendicular to the plane of said panel during movement between said latched and said unlatched positions.

6. The fence and storm shutter system of claim 4 wherein latch bar is moveable by hand between said latched and said unlatched positions.

7. The fence and storm shutter system of claim 4 wherein said latch bar is moveable between said latched and said unlatched positions by a cable operated from a remote location.

8. The fence and storm shutter system of claim 3 wherein said receiver includes a lock moveable between a locked position and an unlocked position, wherein said locked position prevents movement of said latch bar portion and wherein said unlocked position permits movement of said latch bar.

9. A fence and storm shutter system comprising:
at least one panel having a first end and a second end, each said end including at least two second latch portions secured thereto, wherein each said second latch portion is constructed and arranged to interlockingly cooperate with a first latch portion;
at least two posts securable to a ground surface in a substantially parallel arrangement, each said post having at least two of said first latch portions secured thereto, wherein said at least one panel is constructed and arranged to be secured between at least two posts in a substantially horizontal arrangement for assembling a fence;
at least two of said first latch portions securable to opposite sides of a building aperture, wherein said at least two first latch portions are constructed and arranged to align with said second latch portions, wherein said at least one panel may be secured to said second latch portions across said building aperture for protecting said aperture from high winds and flying debris.

10. The fence and storm shutter system of claim 9 wherein said panel is substantially imperforate.

11. The fence and shutter system of claim 9 wherein said first latch portion is a receiver, wherein said receiver is constructed and arranged to cooperate with a striker member for selected retention and release thereof.

12. The fence and storm shutter system of claim 11 wherein said receiver includes a frame, and a latch bar portion, wherein said latch bar portion is moveable between a latched position for retaining said striker member and an unlatched position for releasing said striker member.

13. The fence and storm shutter system of claim 12 wherein said latch bar portion is displaced in a direction substantially perpendicular to the plane of said panel during movement between said latched and said unlatched positions.

14. The fence and storm shutter system of claim 12 wherein latch bar is moveable by hand between said latched and said unlatched positions.

15. The fence and storm shutter system of claim 12 wherein said latch bar is cable operated from a remote location.

16. The fence and storm shutter system of claim 9 wherein said receiver includes a lock moveable between a locked position and an unlocked position, wherein said locked position prevents movement of said latch bar portion and wherein said unlocked position permits movement of said latch bar.
